(19) United States
(12) Patent Application Publication
(10) Pub. No.: US 2009/0209246 A1
(43) Pub. Date: Aug. 20, 2009

(54) METHOD FOR TRANSMITTING INFORMATION AND TERMINAL DEVICE TO RECEIVE DATA

(76) Inventors: Andreas KYNAST, Hildesheim (DE); Ulrich Kersken, Diekholzen (DE)

Correspondence Address: Richard L. Mayer, Esq.;Kenyon & Kenyon, One Broadway, New York, NY, 10004, US

(21) Appl. No.: 12/412,152

(22) Filed: Mar. 26, 2009

Related U.S. Application Data
(63) Continuation of application No. 09/554,553, filed on May 15, 2000, now abandoned.

(30) Foreign Application Priority Data
Nov. 14, 1997 (DE) 197 50 361.6

(51) Int. Cl. H04M 3/00

(52) U.S. Cl. 455/420

(57) ABSTRACT

A method for transmitting information between a data provider and data users is described in which the data users may be different with regard to their data processing capabilities. An interface is provided between the data provider and the data user, via which the data is adapted to the respective data processing capabilities of the data users. Corresponding terminal devices transmit information concerning the terminal device's data processing capabilities with the request for data.

### RELATED APPLICATION INFORMATION

The present application is a continuation of U.S. patent application Ser. No. 09/554,553 filed on May 15, 2000, which was a national phase application based on international application PCT/DE98/02407 filed on Aug. 19, 1998, and claims priority to German Application DE 197 50 361.6 filed on Nov. 14, 1997, and which are hereby incorporated by reference in their entirety.

### FIELD OF THE INVENTION

The present invention relates to a method for transmitting information and a terminal device for receiving data.

### BACKGROUND INFORMATION

Methods for transmitting information and terminal devices are already known in which the data providers provide data services 4, 5 which are each adapted to the data processing capabilities of terminal devices 1, 2 (see FIG. 1). Such systems are, however, very inflexible.

### SUMMARY OF THE INVENTION

In contrast, the method according to the exemplary embodiments and/or exemplary methods of the present invention for transmitting information and the terminal device according to the exemplary embodiments and/or exemplary methods of the present invention for receiving data have the advantage that the data services need no longer be adapted individually to the capabilities of the terminal devices. Rather, it is the case that the data can be generated in a standardized format and can then be correspondingly adapted by interfaces to the capabilities of the terminal devices for data processing. Consequently, terminal devices with varying capabilities can use the same data service. Moreover, the configuration of the terminal devices is simplified since essential functions now need only be present once in the data providers. Since the interfaces are only present with the data providers, errors can be corrected very easily in a central location and the adaptation to new terminal devices need take place only once.

The further measures described herein make advantageous improvements of the objects of the exemplary embodiments and/or exemplary methods of the present invention possible. A radio communications network, a digital mobile telephone network in particular, is used advantageously for the exchange of data. In this connection, data can then be transmitted both from the terminal device to the service provider and in reverse direction.

Exemplary embodiments of the present invention are shown in the drawings and are explained in greater detail in the following description.

### BRIEF DESCRIPTION OF THE DRAWINGS

FIG. 1 shows a conventional method of data exchange between terminal devices and service providers.

FIG. 2 shows the method according to the present invention for exchanging data between a service provider and terminal devices.

### DETAILED DESCRIPTION

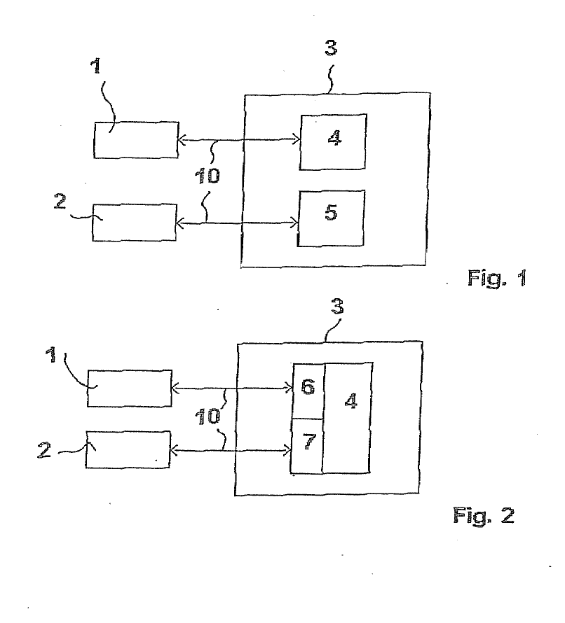

FIG. 1 shows an already known system for transmitting information. This system has data users 1, 2 which, for example, are designed in the form of terminal devices in a motor vehicle, e.g., car radios with supplementary functions. Data users 1, 2, i.e., terminal devices 1, 2, are paired with a data provider 3, i.e., an infrastructure 3. This data provider 3, i.e., infrastructure 3, generates data which is transmitted to the data users via a transmission medium 10. The transmission medium is represented by arrows 10 in this case. Data transmission medium 10 is conceived of in particular as, for example, digital radio telephone systems such as the GSM mobile radio telecommunications system in this case. With the GSM mobile radio telecommunications system, it is possible to transmit data within the context of the Short Message Service. In addition, it is also possible to transmit data via the normal voice channels of the GSM mobile radio telephone, for example in the form of fax data. In this connection, as suggested by arrows 10, data can be transmitted not only by the data providers to terminal devices 1, 2 but terminal devices 1, 2 can also transmit data to data providers 3. In particular, this serves the purpose of requesting appropriate data from data providers 3 initiated by terminal devices 1, 2.

In FIG. 1, data providers 3 have two different data services 4 and 5, each of which is adapted to terminal devices 1 and 2. These different data services 4, 5 can in fact have essentially the same functionality; however, they are adapted to the particular capabilities of terminal devices 1 and 2. Data services 4 and 5 may, for example, include drawing up a travel route for the user, taking the particular currently existing traffic situation into account. Accordingly, the users would enter their starting point and destination in terminal devices 1 and 2 and then transmit this data to service provider 3 via transmission medium 10 with a corresponding request to draw up a travel route. Data services 4 and 5 then generate the optimum travel route and transmit it back to terminal devices 1, 2 via transmission medium 10. Terminal devices 1, 2 differ from each other, however, essentially in the way this information can be displayed. Terminal device 1 has, for example, a small display and a voice output. The optimum route would then be presented by the display of brief location data on the screen and the output of corresponding voice signals as needed. Terminal device 2 has, for example a large color screen. In this terminal device, the information concerning the optimum travel route would then be shown on the screen as a map with appropriate color markings. Due to the different capabilities of the terminal devices, different data services 4, 5 must be provided by the data providers, each being adapted to the data processing capabilities of terminal devices 1, 2.

A method according to the exemplary embodiments and/or exemplary methods of the present invention for transmitting information between a data provider 3 and data users 1, 2 is shown in FIG. 2. Terminal devices 1, 2 of transmission medium 10 and data providers 3 corresponding to the corresponding elements from FIG. 1. These terminal devices differ in particular with regard to their capabilities for processing data, in particular in the display on a screen or output in the form of speech.

The internal configuration of data provider 3 is different from FIG. 1. Data provider 3 has only one data service 4 which is configured independently of the data processing capabilities of terminal devices 1, 2. Before the data is transmitted to the respective terminal devices 1, 2 via transmission medium 10, it is correspondingly adapted to terminal devices 1, 2 by interfaces 6, 7. It is the task of these interfaces 6, 7 to adapt the data provided by data service 4 to the capabilities of terminal devices 1, 2 and, correspondingly, to adapt to data service 4 the information sent by terminal devices 1, 2 to data provider 3. Interfaces are understood here to mean interface converters which are, for example, configured in the form of software and adapt the data from the terminal device to the data service or in reverse direction. For example, terminal device 1 can have a voice input. This voice data is then transmitted to interface 6 and processed there into appropriate information for data service 4. For the example described above, this information can be the starting point and the destination of the planned trip. Using this data, data service 4 determines an optimum route and provides interface 6 with a large amount of information regarding the optimum route. If data service 4, for example, makes a map available, interface 6 converts this information into appropriate data for a brief written display or voice output in terminal device 1 since this corresponds to the capabilities for further data processing of terminal device 1. Therefore, only data in a format that can be processed by terminal device 1 is transmitted from interface 6 by communication medium 10. Terminal device 2 has a larger color screen, with the aid of which the user of terminal device 2 can enter a starting point and destination for his trip (for example, a touch screen). This data is transmitted via communication medium 10 to interface 7 which then generates appropriate input data for data service 4. Data service 4 accordingly draws up the route, in this case, for example, again in the form of a large map which cannot be displayed on the screen of terminal device 2 in that format and size. Interface 7 will then process this data appropriately by processing the map data that is not needed, for example, because the map section made available by data service 4 is too large, to conform to the format that can be displayed in terminal device 2. Only this data is then transmitted via interface 10 to terminal device 2, i.e., terminal device 2 receives in this case also only the data which it can reasonably process further.

The arrangement of the interface at data provider 3 results in the advantage that it is not necessary to create a separate data service for each terminal device 1, 2 which is adapted to the capabilities of the terminal device. Rather, the case is that one data service can be used for completely different terminal devices which may vary greatly with regard to their data processing capability. The expense for creating data services is thus reduced. Moreover, it is accordingly possible to design the terminal devices to be correspondingly simpler since the terminal devices do not need to be adapted to an already existing data service, but rather conversely, the data services are adapted to the capabilities of the terminal devices. This has the additional advantage that if additional terminal devices with new data processing capabilities are introduced, the already existing data services can be easily adapted to these new terminal devices. When new types of terminal devices appear, only the interfaces must be adapted to the new terminal devices.

It is not absolutely essential to arrange interfaces 6, 7 together with data service 4. It is just as conceivable for providers of communication medium 10, for example, operators of digital mobile telephone networks, accordingly to purchase data from service providers and then process it for their mobile telephone customers. In such a case the service provider shown in FIG. 2 would thus be made up of two different providers which, however, from the customer's point of view exist as a single data provider 3.

The shifting of some of the functions from the terminal device to data provider 3 makes it possible for different terminal devices to use the same service. Moreover, the terminal devices are thereby simplified since the necessary extra expense for adapting different terminal devices to the data service is incurred only once by the service providers. In addition, this also makes it very easy to expand existing services with additional functions. Only the interfaces would need to be adapted accordingly. For terminal devices with new display capabilities, only corresponding interfaces need be set in place at the data providers. At the same time, the already existing services can also be used. If errors occur, they can be corrected very easily at a central location at service providers 3 without the need for exchanging the software in all the terminal devices. In principle, it is therefore generally advantageous for the data providers to adapt to the terminal devices and not the reverse.

One option for transmitting the data processing capabilities of the terminal device is to have only one terminal device identifier or one terminal device code stored in the terminal devices, the code then being transmitted to the service providers. A list is stored in the interfaces or the service providers which then permits the identification of specific data processing capabilities.

1-7. (canceled)

8. A method for transmitting information between an infrastructure and data users, the infrastructure including a service provider, the data users including terminal devices in a motor vehicle, the terminal devices having specific different data processing capabilities, the method comprising:
making a single data service available in a standardized format, using the infrastructure; and
via interfaces situated in the infrastructure, adapting data from the single data service in the standardized format to the different data processing capabilities of the terminal devices;
wherein the different data processing capabilities of the terminal devices are identified based on at least one of a terminal device identifier and a terminal device code transmitted by a respective terminal device to the service provider, and
wherein if additional terminal devices with new data processing capabilities are introduced, already existing data services are easily adapted to the new terminal devices by only adapting the interface to the new devices.

9. The method according to claim 8, further comprising the step of carrying-out a transmission between the infrastructure and the data users via a digital mobile telephone network.

10. The method according to claim 8, further comprising the steps of:
transmitting request data from the data users to the infrastructure; and
selecting the data service and at least one of the interfaces as a function of the request data.

11. A terminal device for a reception of data from an infrastructure, the terminal device having specific different data processing capabilities for processing the data, the infrastructure making a single data service available in a standardized format, the infrastructure including interfaces via which the data from the single data service in the standardized format is adapted to the different data processing capabilities of the terminal device, the terminal device comprising:
a transmitting arrangement to transmit a request signal to the infrastructure via which data is requested from the infrastructure and with which information concerning the different data processing capabilities is transmitted via the terminal device to the infrastructure;
wherein the different data processing capabilities of the terminal device are identified based on at least one of a terminal device identifier and a terminal device code transmitted by the terminal device to the service provider, and
wherein if additional terminal devices with new data processing capabilities are introduced, already existing data services are easily adapted to the new terminal devices by only adapting the interface to the new devices.

12. The terminal device according to claim 11, further comprising:
a data exchanging arrangement to exchange data with the infrastructure via a digital mobile telephone network.

13. The terminal device according to claim 11, wherein the terminal device is a car radio with supplementary functions.

14. The terminal device according to claim 11, wherein the information concerning the different data processing capabilities of the terminal device includes the terminal device identifier.

15. A method for transmitting information between an infrastructure and data users, the infrastructure including a service provider, the data users including terminal devices in a motor vehicle, the terminal devices having specific data processing capabilities, the method comprising the steps of:
making a data service available in a standardized format, using the infrastructure; and
via interfaces situated in the infrastructure, adapting data in the standardized format to the data processing capabilities of the terminal devices;
wherein the data includes geographic information,
wherein the different data processing capabilities of the terminal devices are identified based on at least one of a terminal device identifier and a terminal device code transmitted by a respective terminal device to a service provider, and
wherein if additional terminal devices with new data processing capabilities are introduced, already existing data services are easily adapted to the new terminal devices by only adapting the interface to the new devices.

16. A terminal device for a reception of data from an infrastructure, the terminal device having specific different data processing capabilities arranged to process the data, the infrastructure arranged to make a single data service available in a standardized format, the infrastructure including interfaces via which the data from the single data service in the standardized format is adapted to the different data processing capabilities of the terminal device, the terminal device comprising:
an arrangement configured to transmit a request signal to the infrastructure via which data is requested from the infrastructure and with which information concerning the different data processing capabilities is transmitted via the terminal device to the infrastructure;
wherein the different data processing capabilities are identified based on at least one of a terminal device identifier and a terminal device code transmitted by the terminal device to a service provider, and
wherein if additional terminal devices with new data processing capabilities are introduced, already existing data services are easily adapted to the new terminal devices by only adapting the interface to the new devices.

17. A method for transmitting information between an infrastructure and data users, the infrastructure including a service provider having a data service configured independently of the processing capabilities of the data users, the data users including terminal devices in a motor vehicle, the terminal devices having specific different data processing capabilities, the method comprising the steps of:
making a data service available in a standardized format, using the infrastructure;
via interfaces situated in the infrastructure, adapting data from the data service in the standardized format to the different data processing capabilities of the terminal devices; and
transmitting the adapted data to a terminal device;
wherein the different data processing capabilities of the terminal devices are identified based on at least one of a terminal device identifier and a terminal device code transmitted by a respective terminal device to the service provider, and
wherein if additional terminal devices with new data processing capabilities are introduced, already existing data services are easily adapted to the new terminal devices by only adapting the interface to the new devices.

18. A device for transmitting information between an infrastructure and data users, the infrastructure including a service provider having a data service configured independently of the processing capabilities of the data users, the data users including terminal devices in a motor vehicle, the terminal devices having specific different data processing capabilities, comprising:
an arrangement configured to make a data service available in a standardized format, using the infrastructure;
interfaces arranged in the infrastructure and configured to adapt data from the data service in the standardized format to the different data processing capabilities of the terminal devices, which are identified based on at least one of a terminal device identifier and a terminal device code transmitted by a respective terminal device to the service provider; and
a transmitter configured to transmit the adapted data to a terminal device;
wherein if additional terminal devices with new data processing capabilities are introduced, already existing data services are easily adapted to the new terminal devices by only adapting the interface to the new devices.
